(19) United States
(12) Patent Application Publication
(10) Pub. No.: US 2026/0170346 A1
(43) Pub. Date: Jun. 18, 2026

(54) WEIGHTED MODEL FUSION FOR MITIGATING CATASTROPHIC FORGETTING IN CUSTOMIZED GENERATIVE ARTIFICIAL INTELLIGENCE MODELS

(71) Applicant: INTUIT INC., Mountain View, CA (US)

(72) Inventors: Guy LEV, Givaataim (IL); Matan VETZLER, Givat Shmue'l (IL); Omer WOSNER, Modi'in (IL); Gidi ZILBAR, Ein Shemer (IL)

(21) Appl. No.: 18/984,228

(22) Filed: Dec. 17, 2024

(51) Int. Cl. G06N 3/091

(52) U.S. Cl. CPC G06N 3/091

(57) ABSTRACT

A method for mitigating catastrophic forgetting is provided. The method includes providing an input prompt to a classifier machine learning model configured to classify the input prompt as a general knowledge query for a base generative artificial intelligence model, a specific knowledge query for a customized generative artificial intelligence model, or a mixed knowledge query for a weighted fusion model. The method includes computing, based on an output of the classifier machine learning model, a weighted mean of weights of the base generative artificial intelligence model and corresponding weights of the customized generative artificial intelligence model. The method includes generating the weighted fusion model based on the weighted mean of the weights of base generative artificial intelligence model and the corresponding weights of the customized generative artificial intelligence model. The method includes generating, based on the output, a response to the input prompt using the weighted fusion model.

### INTRODUCTION

Aspects of the present disclosure relate to techniques for using weighted model fusion to mitigate catastrophic forgetting in customized generative artificial intelligence models.

### BACKGROUND

Base generative artificial intelligence models are generative artificial intelligence models that are pre-trained using a large corpus of data that includes content from various sources (e.g., books, websites). Through this pre-training, base generative artificial intelligence models acquire general knowledge that may be applicable to a wide range of tasks. However, this general knowledge is limited and, as a result, base generative artificial intelligence models may not know how to perform tasks that are specific to a particular domain of knowledge.

A base generative artificial intelligence model may be customized to perform those tasks that are specific to the particular domain of knowledge. For instance, the base generative artificial intelligence model may be fine-tuned using training data that allows the base generative artificial intelligence to acquire knowledge for performing those tasks that are specific to the particular domain of knowledge. To fine-tune the base generative artificial intelligence model, the parameters of the base generative artificial intelligence model may be updated which, in some instances, can overwrite or interfere with previously learned representations (e.g., knowledge) of the base generative artificial intelligence model. For example, as a result of the fine-tuning, the customized generative artificial intelligence model may no longer possess some of the previously learned knowledge (that is, general knowledge). This occurrence is commonly referred to as catastrophic forgetting.

Accordingly, there is a need in the art for techniques to eliminate (or at least reduce) the occurrence of catastrophic forgetting in customized generative artificial intelligence models.

### BRIEF SUMMARY

Certain embodiments provide a method for mitigating catastrophic forgetting in customized generative artificial intelligence models. The method generally includes: providing an input prompt to a classifier machine learning model configured to classify the input prompt as a general knowledge query for a base generative artificial intelligence model, a specific knowledge query for a customized generative artificial intelligence model, or a mixed knowledge query for a weighted fusion model; receiving an output of the classifier machine learning model, the output indicating the input prompt is classified as the mixed knowledge query; computing, based on the output, a weighted mean of weights of the base generative artificial intelligence model and corresponding weights of the customized generative artificial intelligence model; generating the weighted fusion model based on the weighted mean of the weights of base generative artificial intelligence model and the corresponding weights of the customized generative artificial intelligence model; and generating, based on the output, a response to the input prompt using the weighted fusion model.

Other embodiments comprise systems configured to perform the method set forth above as well as non-transitory computer-readable storage mediums comprising instructions for performing the method set forth above.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 depicts a system for mitigating catastrophic forgetting in customized generative artificial intelligence models, according to certain embodiments.

FIG. 2A depicts the system of FIG. 1 processing a general knowledge query, according to certain embodiments.

FIG. 2B depicts the system of FIG. 1 processing a custom knowledge query, according to certain embodiments.

FIG. 2C depicts the system of FIG. 1 processing a mixed knowledge query, according to certain embodiments.

FIG. 3 depicts example operations related to mitigating catastrophic forgetting in customized generative artificial intelligence models, according to certain embodiments.

FIG. 4 depicts an example processing system for mitigating catastrophic forgetting in customized generative artificial intelligence models, according to certain embodiments.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer-readable mediums for mitigating catastrophic forgetting in customized generative artificial intelligence models.

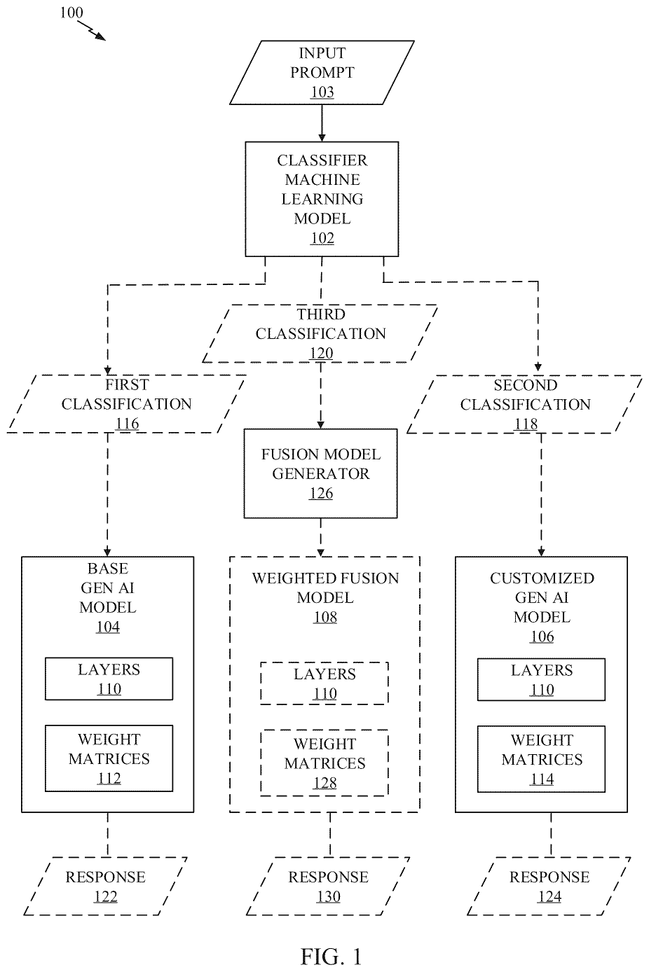

Example aspects of the present disclosure are directed to techniques for mitigating catastrophic forgetting in customized generative artificial intelligence models. For example, the disclosed techniques may include classifying an input prompt (e.g., query) for a generative artificial intelligence model as one of a general knowledge query for a base generative artificial intelligence model, a specific knowledge query for a customized (e.g., fine-tuned) generative artificial intelligence model, and a mixed knowledge query for a weighted fusion model that, as will be discussed below with reference to FIG. 1, represents a hybrid of the base generative artificial intelligence model and the customized artificial intelligence model.

The disclosed techniques may include training a classifier machine learning model to classify input prompts as one of the above-mentioned queries. For example, in some embodiments, the classifier machine learning model may be a generative artificial intelligence model, such as a language processing machine learning model, trained to classify input prompts using training data that is specific to the particular domain of knowledge in which the customized generative artificial intelligence model is fine-tuned to perform specific tasks. For instance, the training data may include examples of input prompts that are specific to the particular domain of knowledge which, in some embodiments, may be finance. In this manner, the classifier machine learning model may learn to classify similar prompts to those included in the training data as specific knowledge queries. Furthermore, the classifier machine learning model may learn to classify prompts that are dissimilar to those prompts included in the training data as general knowledge queries.

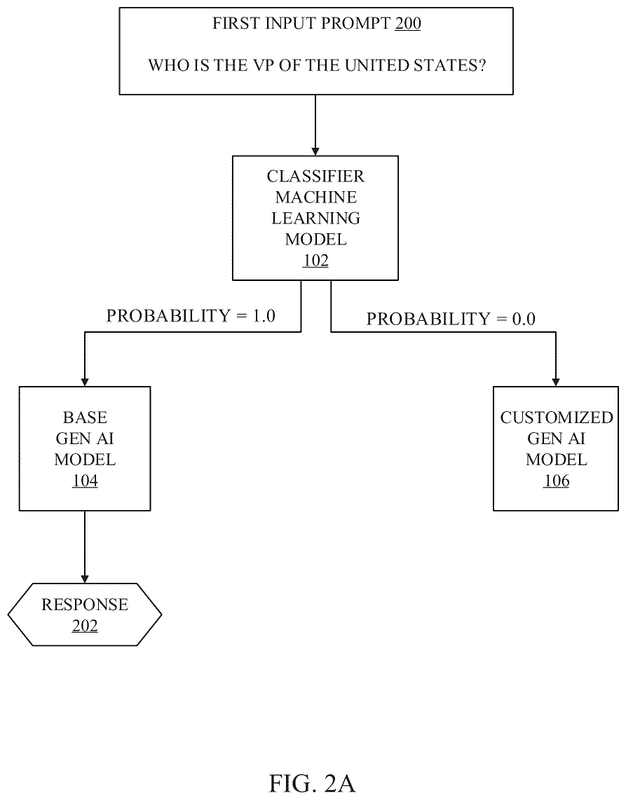

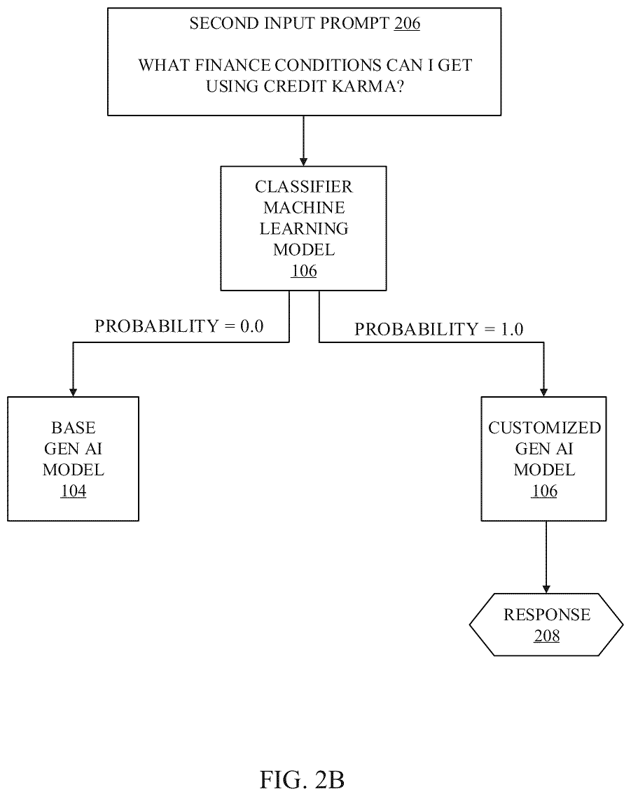

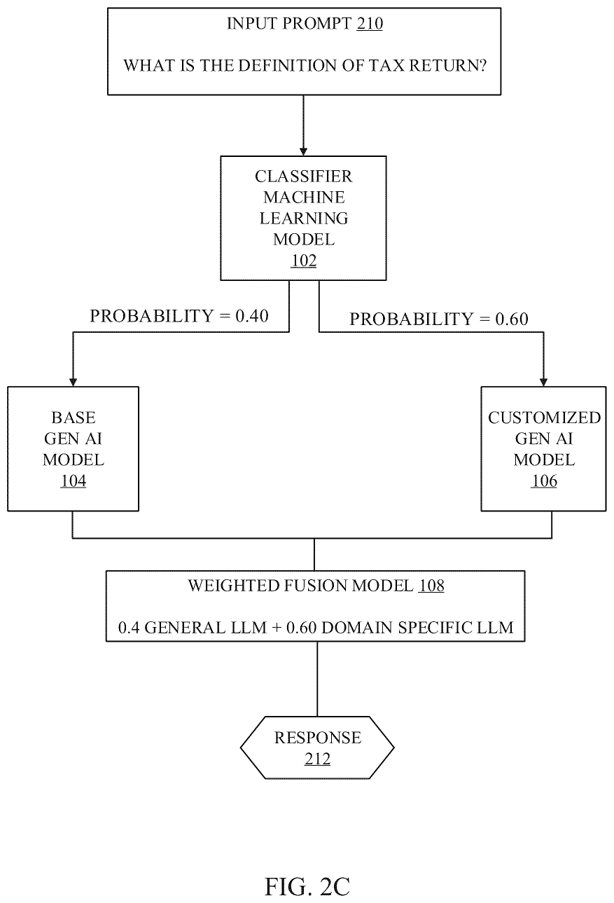

The classifier machine learning model may, as will be discussed below with reference to FIGS. 2A-2C, generate one or more probability scores indicative of the likelihood of an input prompt being a general knowledge query, a specific knowledge query, or a mixed knowledge query. For example, for an input prompt the classifier machine learning model predicts is a general knowledge query, the classifier machine learning model may output a probability score (e.g., having a value of 0) to indicate that the classifier machine learning model predicted the input prompt as a general knowledge query for the base generative artificial intelligence model. As another example, for an input prompt the classifier machine learning model predicts is a specific knowledge query, the classifier machine learning model may output a probability score (e.g., having a value of 1) to indicate that the classifier machine learning model predicted the input prompt as a specific knowledge query for the customized generative artificial intelligence model.

In some embodiments, the classifier machine learning model may output two probability scores for an input prompt that the classifier machine learning model predicts are mixed knowledge queries. For example, the classifier machine learning model may output an indication of a first probability score indicating a likelihood of the input prompt being a general knowledge query and an indication of a second probability score indicating a likelihood of the input prompt being a specific knowledge query. For example, the first probability score and the second probability score may each be non-zero values that are greater than a threshold value (e.g., 0.2). In some embodiments, the first probability score and the second probability score may add up to 1.

For input prompts that the classifier machine learning model classifies as mixed knowledge queries, the disclosed techniques may include generating a weighted fusion model based on the first probability score and the second probability score. For example, the disclosed techniques may include computing, based on the first probability score and the second probability score, a weighted (e.g., according to the first probability score and the second probability score) mean of weights of the base generative artificial intelligence model and corresponding weights of the customized generative artificial intelligence model. In this manner, the weighted fusion model may be configured (e.g., by configuring weights thereof) to generate content in response to the input prompt that, as predicted by the classifier machine learning model, requires general knowledge possessed by the base generative artificial intelligence model and specific knowledge (e.g., within the particular domain of knowledge) possessed by the customized machine learning model.

Example aspects of the present disclosure provide numerous technical effects and benefits. For instance, by generating a weighted fusion model to generate content for mixed knowledge queries, the disclosed techniques produce improved (e.g., more accurate) content compared to existing techniques that rely on customized (e.g., fine-tuned) generative artificial intelligence models that may have catastrophically forgotten information needed to generate accurate content for such mixed knowledge queries. Techniques described herein overcome the technical challenge of catastrophic forgetting that may occur in customized generative artificial intelligence models through the creation of a weighted fusion model that may be selected for use when a query is classified as a mixed knowledge query and through a particular process for classifying queries as general knowledge queries, specific knowledge queries, or mixed knowledge queries. Furthermore, the disclosed techniques improve the efficiency of computing resources because the disclosed techniques may eliminate (or at least reduce) instances in which computing resources are wasted generating content (e.g., incorrect information) for such mixed knowledge queries that is not accurate and/or not relevant.

### Example System for Weighted Model Fusion

FIG. 1 depicts a system 100 for weighted model fusion according to some embodiments of the present disclosure.

The system 100 may include a classifier machine learning model 102 configured to predict an input prompt 103 for a generative artificial intelligence model belongs to one of a plurality of different classifications. For instance, the different classifications may include a general knowledge query for a base generative artificial intelligence model 104 capable of performing general knowledge tasks, a specific knowledge query for a customized generative artificial intelligence model 106 capable of performing tasks within a particular domain of knowledge (e.g., finance), or a mixed knowledge query for a weighted fusion model 108 that, as will be discussed below in more detail, may be a hybrid of the base generative artificial intelligence model 104 and the customized generative artificial intelligence model 106.

In some embodiments, the classifier machine learning model 102 may be trained (e.g., through a supervised learning process) using training data that is relevant to the domain of knowledge in which the customized generative artificial intelligence model 106 is capable of performing tasks. For instance, the training data may include examples of different input prompts that are specific to the tasks the customized generative artificial intelligence model 106 performs in the particular domain of knowledge (e.g., the input prompts in the training data may be associated with labels indicating that these input prompts are specific to the tasks the customized generative artificial intelligence model 106 performs in the particular domain of knowledge). In this manner, the classifier machine learning model 102 may learn from these example input prompts and, as a result, may be able to correctly classify similar input prompts as specific knowledge queries for the customized generative artificial intelligence model 106.

In some embodiments, the base generative artificial intelligence model 104 may be a language processing machine learning model, such as a large language model (LLM), pre-trained using a large corpus of text data that include millions (or billions) of words from many different sources (e.g., websites, books, etc.). In this manner, the language processing machine learning model may acquire general knowledge that can be applied to a wide range of tasks.

The customized generative artificial intelligence model 106 may be a base generative artificial intelligence model, such as the base generative artificial intelligence model 104, that has been customized (e.g., fine-tuned) to perform tasks within a particular domain of knowledge. For instance, in some embodiments, the customized generative artificial intelligence model 106 may be a base language processing machine learning model that has been fine-tuned to perform the tasks within the particular domain of knowledge. In some embodiments, the base language processing machine learning model may be fine-tuned using training data that allows the language processing machine learning model to learn how to perform the tasks within the particular domain of knowledge.

In some embodiments, the base generative artificial intelligence model 104 and the customized generative artificial intelligence model 106 may each have the same architecture. For instance, the base generative artificial intelligence model 104 and the customized generative artificial intelligence model 106 may each include a plurality of layers 110 (e.g., input layer, one or more hidden layers, and an output layer). The base generative artificial intelligence model 104 and the customized generative artificial intelligence model 106 may each also include a plurality of weight matrices 112, 114.

Each respective weight matrix of the plurality of weight matrices 112, 114 may be populated with values (e.g., weights) indicative of the strength of the connections between neurons in adjacent layers of the model (e.g., base generative artificial intelligence model 104 and customized generative artificial intelligence model 106). For example, a first weight matrix of the plurality of weight matrices 112 of the base generative artificial intelligence model 104 may indicate a strength of connections between input features at an input layer of the layers 110 and neurons in an adjacent layer (e.g., first hidden layer) of the layers 110. More specifically, the first weight matrix of the weight matrices 112 of the base generative artificial intelligence model 104 may include a plurality of values, with each value corresponding to a different weight associated with a corresponding input feature at the input layer and a corresponding neuron in the adjacent layer.

The weight matrices 114 of the customized generative artificial intelligence model 106 may include a similar first weight matrix. However, the values (e.g., weights) included in the first weight matrix of the weight matrices 114 for the customized generative artificial intelligence model 106 may be different from the values included in the first weight matrix of the weight matrices 112 for the base generative artificial intelligence model 104 since the customized generative artificial intelligence model 106 is fine-tuned (e.g., customized) to perform tasks within the particular domain of knowledge as opposed to general knowledge tasks (e.g., summarizing a meeting) performed by the base generative artificial intelligence model 104.

As illustrated, the classifier machine learning model 102 may be configured to generate an output indicating a classification for the input prompt 103. For instance, the output may include a first classification 116 (e.g. corresponding to a general knowledge query for the base generative artificial intelligence model 104), a second classification 118 (e.g., corresponding to a specific knowledge query for the customized generative artificial intelligence model 106), or a third classification 120 (e.g., corresponding to a mixed knowledge query for the weighted fusion model 108).

In some embodiments, the first classification 116, the second classification 118, and the third classification 120 may include one or more probability scores (e.g., ranging from 0 to 1) indicative of the likelihood that that the input prompt 103 is a general knowledge query. For example, as will be discussed with reference to FIGS. 2A, 2B, and 2C, the one or more probability scores may include a first probability score for the input prompt 103 being a general knowledge query for the base generative artificial intelligence model 104 and a second probability score for the input prompt 103 being a specific knowledge query for the customized generative artificial intelligence model 106. In some embodiments, the classifier machine learning model 102 only outputs one probability score (e.g., the second probability score for the input prompt 103 being a specific knowledge query) and another probability score (e.g., the first probability score for the input prompt 103 being a general knowledge query) may be inferred based on that output probability score. For example, if the output probability score is 0.3 (that is, there is a thirty-percent chance that the input prompt 103 is a specific knowledge query) then the other probability score indicative of the input prompt 103 being a general knowledge query may be determined to be 0.7 (e.g., because it is known that the two probability scores should add up to one). For instance, if the model outputs a probability score for the input prompt 103 being a specific knowledge query of p, then the probability score for the input prompt 103 being a general knowledge query may be computed as 1−p.

When the classifier machine learning model 102 predicts the input prompt 103 corresponds to the first classification 116 (e.g., general knowledge query), the base generative artificial intelligence model 104 may generate a response 122 to the input prompt 103. Alternatively, the customized generative artificial intelligence model 106 may generate a response 124 to the input prompt 103 when the classifier machine learning model 102 predicts the input prompt 103 corresponds to the second classification 118 (e.g., specific knowledge query).

When the classifier machine learning model 102 predicts the input prompt 103 corresponds to the third classification 120 (e.g., mixed knowledge query), a fusion model generator 126 of the system 100 may generate the weighted fusion model 108. For example, the fusion model generator 126 may be configured to compute a weighted mean of weights of the base generative artificial intelligence model 104 and corresponding weights of the customized generative artificial intelligence model 106 based on a first probability score (e.g., which may be output by the classifier machine learning model 106) indicative of how likely the input prompt 103 is a general knowledge query for the base generative artificial intelligence model 104 and based on the second probability score (e.g., which may be output by the classifier machine learning model 106) indicative of how likely the input prompt 103 is a specific knowledge query for the customized generative artificial intelligence model 106.

In some embodiments, the fusion model generator 126 may generate a plurality of weight matrices 128 for the weighted fusion model 108 based on the weighted mean of the weights of the base generative artificial intelligence model 104 and the corresponding weights of customized generative artificial intelligence model 106. For example, when computing the weighted mean, values (e.g., weights) included in weight matrices 112 for the base generative artificial intelligence model 104 may be weighted according to the probability score for the input prompt 103 being a general knowledge query while values included in weight matrices 114 for the customized generative artificial intelligence model 106 may be weighted according to the probability score for the input prompt 103 being a specific knowledge query. In one example, the weights of the weight matrices 128 for the weighted fusion model 108 are determined by the probability p, with the formula (1−p)*weights_of_original_model+p*weights_of_fine_tuned_model, where p represents the probability score for the input prompt 103 being a specific knowledge query (e.g., the probability score output by classifier machine learning model 106), 1−p represents the probability score for the input prompt 103 being a general knowledge query, weights_of_original_model represents the weight matrices 112 of base generative artificial intelligence model 104, and weights_of_fine_tuned_model represents the weight matrices 114 of customized generative artificial intelligence model 106.

It should be appreciated that the values included in each of the weight matrices 128 of the weighted fusion model 108 may be different from the values included in the corresponding weight matrices 112, 114 for the base generative artificial intelligence model 104 and the customized generative artificial intelligence model 106. In this manner, the weighted fusion model 108 may be a hybrid of the base generative artificial intelligence model 104 and the customized generative artificial intelligence model 106 and may therefore generate a response 130 to the input prompt 103 without experiencing catastrophic forgetting which, as discussed above, occurs when customized generative artificial intelligence models, such as the customized generative artificial intelligence model 106, are asked mixed knowledge queries about knowledge the customized generative artificial intelligence models forgot (e.g., catastrophically) as a result of being customized (e.g., fine-tuned) for a particular purpose, such as performing tasks within a particular domain of knowledge.

### Example Classification of Different Input Prompts

FIGS. 2A-2C depict example input prompts being classified (e.g., as general knowledge query, specific knowledge query, and mixed knowledge query) according to some embodiments of the present disclosure. For simplicity, classification of the different input prompts will be discussed with reference to the system 100 of FIG. 1.

FIG. 2A depicts a first input prompt 200 according to some embodiments of the present disclosure. For example, the first input prompt 200 may be a query (e.g., including natural language text) for a generative artificial intelligence model. The classifier machine learning model 102 may receive the first input prompt 200 and may process the first input prompt 200 to output one or more probability scores indicative of a classification (e.g., general knowledge query) of the first input prompt 200.

In some embodiments, the classifier machine learning model 102 may output a first probability score (e.g., having a value of 1) indicative of a likelihood of the first input prompt 200 being a general knowledge query for the base generative artificial intelligence model 104. Furthermore, in some embodiments, the classifier machine learning model 102 may output a second probability score (e.g., having a value of 0) indicative of the likelihood of the first input prompt 200 being a specific knowledge query for the customized generative artificial intelligence model 106.

In some embodiments, the classifier machine learning model 102 may only output the second probability score (e.g., instead of both the first probability score and the second probability score) with a value of zero, indicating that the classifier machine learning model 102 predicts the first input prompt 200 is a general knowledge query for the base generative artificial intelligence model 104. Thus, with the first input prompt 200 predicted as a general knowledge query, the base generative artificial intelligence model 104 may generate a response 202 to the first input prompt 200.

FIG. 2B depicts a second input prompt 206 according to some embodiments of the present disclosure. For example, the second input prompt 206 may be a query (e.g., including natural language text) for a generative artificial intelligence model. The classifier machine learning model 102 may receive the second input prompt 206 and may process the second input prompt 206 to output one or more probability scores indicative of a classification (e.g., specific knowledge query) of the second input prompt 206.

In some embodiments, the classifier machine learning model 102 may output a first probability score (e.g., having a value of 1) indicative of the likelihood of the second input prompt 206 being a specific knowledge query for the customized generative artificial intelligence model 106. Furthermore, in some embodiments, the classifier machine learning model 102 may output a second probability score (e.g., having a value of 0) indicative of the likelihood of the second input prompt 206 being a general knowledge query for the base generative artificial intelligence model 104.

In some embodiments, the classifier machine learning model 102 may only output the second probability score (e.g., instead of both the first probability score and the second probability score) with a value of one, indicating that the classifier machine learning model 102 predicts the second input prompt 206 is a specific knowledge query for the customized generative artificial intelligence model 106. Thus, with the second input prompt 204 predicted as a general knowledge query, the customized generative artificial intelligence model 106 may generate a response 202 to the first input prompt 200.

FIG. 2C depicts a third input prompt 210 according to some embodiments of the present disclosure. For example, the third input prompt 210 may be a query (e.g., including natural language text). The classifier machine learning model 102 may receive the third input prompt 210 and may process the third input prompt 210 to output one or more probability scores indicative of a classification (e.g., general knowledge query, specific knowledge query, mixed knowledge query) of the second input prompt 206.

As illustrated, the classifier machine learning model 102 may output a first probability score having a non-zero value (e.g., illustrated as 0.4) and indicative of the likelihood of the third input prompt 210 being a specific knowledge query for the customized generative artificial intelligence model 106. Furthermore, in some embodiments, the classifier machine learning model 102 may output a second probability score having a non-zero value (e.g., illustrated as 0.6) and indicative of the likelihood of the third input prompt 210 being a general knowledge query for the base generative artificial intelligence model 104.

In some embodiments, the classifier machine learning model 102 may only output the second probability score (e.g., instead of both the first probability score and the second probability score) with a value of 0.6, indicating that the classifier machine learning model 102 predicts the third input prompt 210 is 60% likely to be a specific knowledge query for the customized generative artificial intelligence model 106. In some embodiments, the first probability score and the second probability score may each be greater than a threshold value (e.g., at least 0.2). Thus, in some aspects, input prompt 210 may be determined to be a mixed knowledge query, such as based on the predicted probability of the third input prompt 210 being a specific knowledge query falling within a certain range (e.g., above a lower threshold and below an upper threshold).

In some embodiments, a fusion model generator (e.g., the fusion model generator 126 of FIG. 1) may generate the weighted fusion model 108 to generate a response to the third input prompt 210. For example, the fusion model generator may be configured to compute a weighted mean of weights of the base generative artificial intelligence model 104 and corresponding weights of the the customized generative artificial intelligence model 106 based on the first probability score (e.g., 0.4) indicative of how likely the third input prompt 210 is a general knowledge query for the base generative artificial intelligence model 104 and based on the second probability score (e.g., 0.6) indicative of how likely the third input prompt 210 is a specific knowledge query for the customized generative artificial intelligence model 106.

In some embodiments, the fusion model 126 may generate a plurality of weight matrices (e.g., weighted matrices 128 of FIG. 1) for the weighted fusion model 108 based on the weighted mean computed for weights of the base generative artificial intelligence model 104 and the corresponding weights of the customized generative artificial intelligence model 106. For instance, when computing the weighted mean of the weight matrices of the base generative artificial intelligence model 104 and the weight matrices of the customized generative artificial intelligence model 106, the weight matrices of the base generative artificial intelligence model 104 may be weighted based on (e.g., multiplied by) the probability value of 0.4 and the weight matrices of the customized generative artificial intelligence model 106 may be weighted based on (e.g., multiplied by) the probability value of 0.6.

It should be appreciated that the values included in each of the weight matrices of the weighted fusion model 108 may be different from the values included in the corresponding weight matrices 112, 114 of the base generative artificial intelligence model 104 and the customized generative artificial intelligence model 106. In this manner, the weighted fusion model 108 may be a hybrid of the base generative artificial intelligence model 104 and the customized generative artificial intelligence model 106 and may therefore generate a response 130 to the input prompt 103 without experiencing catastrophic forgetting which, as discussed above, occurs when customized generative artificial intelligence models, such as the customized generative artificial intelligence model 106, are asked mixed knowledge queries about knowledge the customized generative artificial intelligence models forgot (e.g., catastrophically) as a result of being customized (e.g., fine-tuned) for a particular purpose, such as performing tasks within a particular domain of knowledge.

### Example Operations for Generating a Weighted Fusion Model to Mitigate Catastrophic Forgetting for Mixed Knowledge Queries

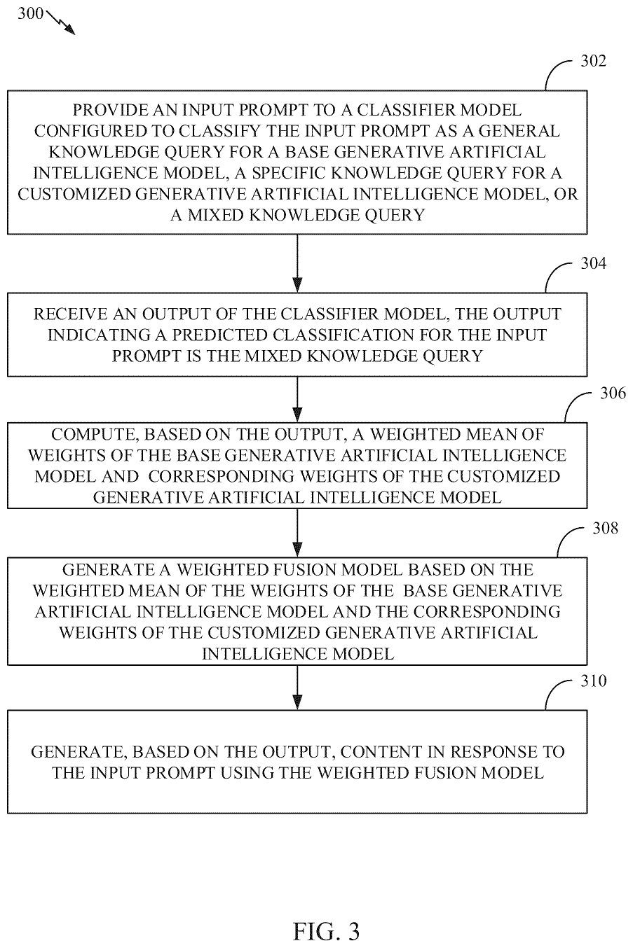

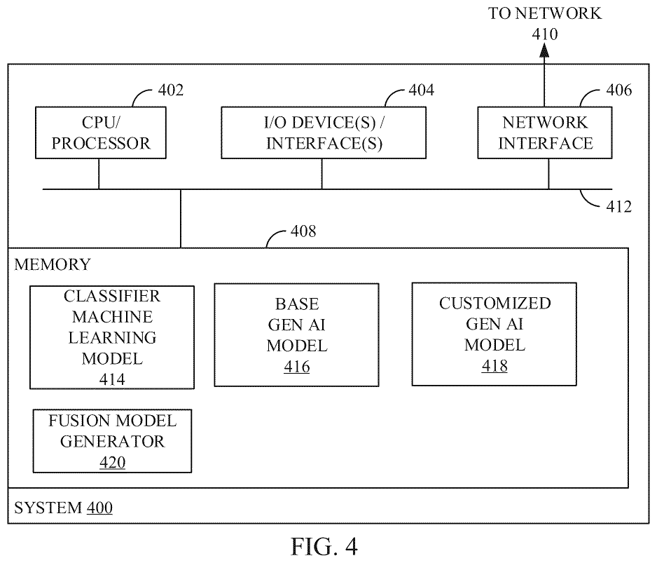

FIG. 3 depicts example operations 300 for mitigating catastrophic forgetting in domain specific language processing machine learning models according to some embodiments of the present disclosure. For example, operations 300 may be performed by one or more components described above with respect to FIG. 1, the system 400 of FIG. 4 (described below), and/or one or more other components and/or devices.

At (302), the operations 300 include providing an input prompt to a classifier machine learning model, such as the classifier machine learning model 102 discussed above with reference to FIG. 1. The classifier machine learning model may be configured to classify the input prompt as one of a general knowledge query for a base generative artificial intelligence model as illustrated in FIG. 2A, a specific knowledge query for a customized generative artificial intelligence model as illustrated in FIG. 2B, or a mixed knowledge query as illustrated in FIG. 2C.

At (304), the operations 300 include receiving an output of the classifier machine learning model. The output may indicate that the input prompt is a mixed-knowledge query. In some embodiments, the output of the classifier machine learning model may include a probability score, p, having a non-zero value (e.g., greater than a threshold value) indicating a likelihood that the input prompt is a specific knowledge query for a customized generative artificial intelligence model (e.g., customized generative artificial intelligence model 106 of FIG. 1). Another probability score indicating a likelihood that the input prompt is a general knowledge query for a base generative artificial intelligence model (e.g, base generative artificial intelligence model 104 of FIG. 1) may be inferred based on the probability score output by the classifier machine learning model. For example, as discussed above with reference to FIG. 2C, the probability score indicating the likelihood that the input prompt is the general knowledge query may be determined by the formula 1−p where, as mentioned above, p corresponds to probability score output by the classifier machine learning model and indicating the likelihood of the input prompt being a specific knowledge query.

At (306), the operations 300 include computing, based on the output, a weighted mean of weights of the base generative artificial intelligence model and corresponding weights of the customized generative artificial intelligence model. For example, in some embodiments, computing the weighted mean may include multiplying each value included in one or more weight matrices for the base generative artificial intelligence model by the probability score (e.g., 1−p) indicating the likelihood of the input prompt being a general knowledge query and multiplying each value included in one or more weight matrices for the customized generative artificial intelligence model by the probability score (e.g., p) indicating the likelihood of the input prompt being a specific knowledge query.

At (308), the operations 300 include generating a weighted fusion model based on the weighted mean of the weights for the base generative artificial intelligence model and the corresponding weights for the customized generative artificial intelligence model. For example, the weight matrices of the weighted fusion model may be generated based on the weighted mean of the weights for the base generative artificial intelligence model and the corresponding weights for the customized generative artificial intelligence model.

In some embodiments, the output of the classifier machine learning model may indicate that there is a higher likelihood that the input prompt is a general knowledge query for the base generative artificial intelligence model. For instance, the probability score indicating a likelihood the input prompt is a general knowledge query may be higher than the probability score (e.g, output by the classifier machine learning model) indicating a likelihood the input prompt is a specific knowledge query. In such embodiments, the weights of the base generative artificial intelligence may be weighted more heavily in the weighted fusion model than the corresponding weights of the customized generative artificial intelligence model.

At (310), the operations 300 include generating a response to the input using the weighted fusion model. For example, the input prompt may be a query and the response may be an answer (e.g, including natural language text) to the query.

In certain embodiments, the operations 300 may include receiving user feedback on the response generated at (310) for the input prompt. For instance, the user feedback may indicate whether a user found the response generated by the weighted fusion model helpful or unhelpful. Furthermore, in some embodiments, the user feedback may be used to train (or re-train) the classifier machine learning model to improve the classification of subsequent input prompts that are also mixed knowledge queries.

### Example Computing System

FIG. 4 illustrates an example system 400 with which embodiments of the present disclosure may be implemented. For example, system 400 may be configured to perform one or more of operations 300 of FIG. 3.

System 400 includes a central processing unit (CPU) 402, one or more I/O device interfaces 404 that may allow for the connection of various I/O devices 404 (e.g., keyboards, displays, mouse devices, pen input, etc.) to the system 400, network interface 406, a memory 408, and an interconnect 412. It is contemplated that one or more components of system 400 may be located remotely and accessed via a network 410. It is further contemplated that one or more components of system 400 may comprise physical components or virtualized components.

CPU 402 may retrieve and execute programming instructions stored in the memory 408. Similarly, the CPU 402 may retrieve and store application data residing in the memory 408. The interconnect 412 transmits programming instructions and application data, among the CPU 402, I/O device interface 404, network interface 406, and memory 408. CPU 402 is included to be representative of a single CPU, multiple CPUs, a single CPU having multiple processing cores, and other arrangements.

Additionally, the memory 408 is included to be representative of a random access memory or the like. In some embodiments, memory 408 may comprise a disk drive, solid state drive, or a collection of storage devices distributed across multiple storage systems. Although shown as a single unit, the memory 408 may be a combination of fixed and/or removable storage devices, such as fixed disc drives, removable memory cards or optical storage, network attached storage (NAS), or a storage area-network (SAN).

As shown, memory 408 includes a classifier machine learning model 414, a base generative artificial intelligence model 416, a customized generative artificial intelligence model 418, and a fusion model generator 420. The classifier machine learning model 414, base generative artificial intelligence model 416, customized generative artificial intelligence model 418, and fusion model generator 420 may be representative of the classifier machine learning model 102, base generative artificial intelligence model 104, customized generative artificial intelligence model 16, and the fusion model generator 126 discussed above with reference to FIG. 1.

It is noted that system 400 is included as an example, and certain functionality described with respect to system 400 and/or otherwise described herein may be implemented via more or fewer devices and/or components.

### Additional Considerations

The preceding description provides examples, and is not limiting of the scope, applicability, or embodiments set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The preceding description is provided to enable any person skilled in the art to practice the various embodiments described herein. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and other operations. Also, “determining” may include receiving (e.g., receiving information), accessing (e.g., accessing data in a memory) and other operations. Also, “determining” may include resolving, selecting, choosing, establishing and other operations.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

A processing system may be implemented with a bus architecture. The bus may include any number of interconnecting buses and bridges depending on the specific application of the processing system and the overall design constraints. The bus may link together various circuits including a processor, machine-readable media, and input/output devices, among others. A user interface (e.g., keypad, display, mouse, joystick, etc.) may also be connected to the bus. The bus may also link various other circuits such as timing sources, peripherals, voltage regulators, power management circuits, and other types of circuits, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media, such as any medium that facilitates transfer of a computer program from one place to another. The processor may be responsible for managing the bus and general processing, including the execution of software modules stored on the computer-readable storage media. A computer-readable storage medium may be coupled to a processor such that the processor can read information from, and write information to, the storage medium. In the alternative, the storage medium may be integral to the processor. By way of example, the computer-readable media may include a transmission line, a carrier wave modulated by data, and/or a computer readable storage medium with instructions stored thereon separate from the wireless node, all of which may be accessed by the processor through the bus interface. Alternatively, or in addition, the computer-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module, it will be understood that such functionality is implemented by the processor when executing instructions from that software module.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for mitigating catastrophic forgetting, comprising:
providing an input prompt to a classifier machine learning model configured to classify the input prompt as a general knowledge query for a base generative artificial intelligence model, a specific knowledge query for a customized generative artificial intelligence model, or a mixed knowledge query for a weighted fusion model;
receiving an output of the classifier machine learning model, the output indicating the input prompt is classified as the mixed knowledge query;
computing, based on the output, a weighted mean of weights of the base generative artificial intelligence model and corresponding weights of the customized generative artificial intelligence model;
generating the weighted fusion model based on the weighted mean of the weights of base generative artificial intelligence model and the corresponding weights of the customized generative artificial intelligence model; and
generating, based on the output, a response to the input prompt using the weighted fusion model.

2. The method of claim 1, wherein the output indicating the input prompt is classified as the mixed knowledge query indicates:
a first probability score indicating a likelihood of the input prompt being the general knowledge query; and
a second probability score indicating a likelihood of the input prompt being the specific knowledge query.

3. The method of claim 2, wherein when the first probability score is higher than the second probability score, the weights of the base generative artificial intelligence model are weighted more highly in the weighted mean than the corresponding weights of the customized generative artificial intelligence model.

4. The method of claim 2, wherein computing the weighted mean of the weights of the base generative artificial intelligence model and the corresponding weights of the customized generative artificial intelligence model comprises:
weighting the weights of the base generative artificial intelligence model based on the first probability score; and
weighting the corresponding weights of the customized generative artificial intelligence model based on the second probability score.

5. The method of claim 4, wherein:
the base generative artificial intelligence model and the customized generative artificial intelligence model each include a plurality of layers and a plurality of weight matrices;
computing the weighted mean of the weights of the base generative artificial intelligence model and the corresponding weights of the customized generative artificial intelligence model comprises multiplying each value included in each respective weight matrix of the plurality of weight matrices of the base generative artificial intelligence model by the first probability score and multiplying each value included in each respective weight matrix of the plurality of weight matrices of the customized generative artificial intelligence model by the second probability score.

6. The method of claim 1, wherein the base generative artificial intelligence model and the customized generative artificial intelligence model each comprise a neural network having a same number of layers.

7. The method of claim 1, wherein the classifier machine learning model comprises a language processing machine learning model.

8. The method of claim 1, wherein the base generative artificial intelligence model and the customized generative artificial intelligence model each comprise a language processing machine learning model.

9. The method of claim 1, further comprising:
receiving user feedback regarding the response to the input prompt; and
training the classifier machine learning model based on the user feedback.

10. A system for mitigating catastrophic forgetting, comprising:
one or more processors; and
a memory comprising instructions that, when executed by the one or more processors, cause the system to perform a method comprising:
providing an input prompt to a classifier machine learning model configured to classify the input prompt as a general knowledge query for a base generative artificial intelligence model, a specific knowledge query for a customized generative artificial intelligence model, or a mixed knowledge query for a weighted fusion model;
receiving an output of the classifier machine learning model, the output indicating the input prompt is classified as the mixed knowledge query;
computing, based on the output, a weighted mean of weights of the base generative artificial intelligence model and corresponding weights of the customized generative artificial intelligence model;
generating the weighted fusion model based on the weighted mean of the weights of base generative artificial intelligence model and the corresponding weights of the customized generative artificial intelligence model; and
generating, based on the output, a response to the input prompt using the weighted fusion model.

11. The system of claim 10, wherein the output indicating the input prompt is classified as the mixed knowledge query indicates:
a first probability score indicating a likelihood of the input prompt being the general knowledge query; and
a second probability score indicating a likelihood of the input prompt being the specific knowledge query.

12. The system of claim 11, wherein when the first probability score is higher than the second probability score, the weights of the base generative artificial intelligence model are weighted more highly in the weighted mean than the corresponding weights of the customized generative artificial intelligence model.

13. The system of claim 11, wherein computing the weighted mean of the weights of the base generative artificial intelligence model and the corresponding weights of the customized generative artificial intelligence model comprises:
weighting the weights of the base generative artificial intelligence model based on the first probability score; and
weighting the corresponding weights of the customized generative artificial intelligence model based on the second probability score.

14. The system of claim 13, wherein:
the base generative artificial intelligence model and the customized generative artificial intelligence model each include a plurality of layers and a plurality of weight matrices;
computing the weighted mean of the weights of the base generative artificial intelligence model and the corresponding weights of the customized generative artificial intelligence model comprises multiplying each value included in each respective weight matrix of the plurality of weight matrices of the base generative artificial intelligence model by the first probability score and multiplying each value included in each respective weight matrix of the plurality of weight matrices of the customized generative artificial intelligence model by the second probability score.

15. The system of claim 10, wherein the base generative artificial intelligence model and the customized generative artificial intelligence model each comprise a neural network having a same number of layers.

16. The system of claim 10, wherein the classifier machine learning model comprises a language processing machine learning model.

17. The system of claim 10, wherein the base generative artificial intelligence model and the customized generative artificial intelligence model each comprise a language processing machine learning model.

18. The system of claim 10, further comprising:
receiving user feedback regarding the response to the input prompt; and
training the classifier machine learning model based on the user feedback.

19. The system of claim 10, wherein the input prompt comprises a query and the response comprises an answer to the query.

20. A non-transitory computer-readable medium comprising instructions to be executed in a processing system for mitigating catastrophic forgetting, wherein the instructions, when executed in the processing system, cause the processing system to perform a method comprising:
providing an input prompt to a classifier machine learning model configured to classify the input prompt as a general knowledge query for a base generative artificial intelligence model, a specific knowledge query for a customized generative artificial intelligence model, or a mixed knowledge query for a weighted fusion model;
receiving an output of the classifier machine learning model, the output indicating the input prompt is classified as the mixed knowledge query;
computing, based on the output, a weighted mean of weights of the base generative artificial intelligence model and corresponding weights of the customized generative artificial intelligence model;
generating the weighted fusion model based on the weighted mean of the weights of base generative artificial intelligence model and the corresponding weights of the customized generative artificial intelligence model; and
generating, based on the output, a response to the input prompt using the weighted fusion model.
